(19) United States
(12) Patent Application Publication
(10) Pub. No.: US 2026/0116452 A1
(43) Pub. Date: Apr. 30, 2026

(54) Dolly Bracket

(71) Applicant: Snap-Loc Cargo Control Systems, LLC, Las Vegas, NV (US)

(72) Inventor: Jeffrey Sciarretta, Taylor, TX (US)

(21) Appl. No.: 19/372,149

(22) Filed: Oct. 28, 2025

Related U.S. Application Data
(60) Provisional application No. 63/712,989, filed on Oct. 28, 2024.

(51) Int. Cl. B62B 5/00

(52) U.S. Cl. CPC B62B 5/0093; B62B 2301/05; B62B 2501/00

(57) ABSTRACT

The present invention relates to a bracket (i.e., dolly bracket) for assembling a dolly using lumber and plate mount swivel casters. The dolly bracket of the present invention is designed to secure opposing end pieces of lumber together, provide the necessary support to the corners of the lumber to support the weight of the goods placed on the dolly, as well as provide a mechanism for securing the plate mount swivel casters to the lumber. The dolly bracket has a flat plate portion having two side walls positioned perpendicular to one another, the bracket further including two parallel rows of holes in the flat plate for fastening a caster to the deck material through the two parallel rows of holes in the bracket and a second set of holes on each of the two side walls for securing the side walls to the deck material. The present invention may also be sold as a kit that includes: (i) at least four pieces of lumber having opposing ends cut at forty-five degree angles, where the forty-five degree angle are cuts in opposing direction to one another; (2) at least four plate mount swivel casters; and (3) at least four brackets of the present invention.

### CROSS-REFERENCE TO RELATED APPLICATIONS

This application claims priority to U.S. Provisional Patent Application Ser. No. 63/712,989, filed Oct. 28, 2024, titled DOLLY BRACKET, which application is incorporated by reference into this application in its entirety.

### FIELD OF THE INVENTION

The invention relates to a bracket for use in assembling a dolly, a dolly assembled using the bracket, a kit for creating a dolly using the bracket and a method for assembling a dolly using lumber and the bracket of the present invention.

### BACKGROUND OF THE INVENTION

Dollies are known for assisting with material handling. Dollies allow individuals to quickly move heavy or large items, and large quantities of goods from one location to another. Using dollies reduces the risk of accidents and injury to the person and to the item or items being moved.

Furniture or pushcart type dollies are comprised of flat closed or partially open platforms or decks with swivel casters attached directly to the underside of the deck. Generally, one caster is on the underside of each corner of the deck. The decks of dollies are designed to receive the casters. Dollies can be expensive, generally come in standard sizes and can be difficult store.

While it is possible to attach casters directly to two parallel pieces of lumber, such as 2×4 or 2×6 pieces of lumber, to create dollies, this construction requires the attachment of additional lumber perpendicularly across the parallel lumber to secure the pieces together, which does not allow for the creation of flat surface. A need therefore exists for individuals or companies to be able to create one or more customized dollies with little expense that have flat decks.

### SUMMARY

The present invention relates to a bracket (i.e., dolly bracket) for assembling a dolly using lumber and plate mount swivel casters. The dolly bracket of the present invention is designed to secure opposing end pieces of lumber together, provide the necessary support to the corners of the lumber to support the weight of the goods placed on the dolly, as well as provide a mechanism for securing the plate mount swivel casters to the lumber.

The bracket of the present invention includes a flat plate having two raised side walls positioned perpendicular to one another for abutting against the exterior ends of the flat deck material that form the corners of the dolly. The flat plate of the bracket further includes holes for securing the casters to the flat deck material through the securing bracket. The raised side walls each have a set of holes for securing the bracket to abutting deck materials. Optionally, additional holes may be included in the bracket for further securing the bracket to the flat deck material. Various opening and holes may be provided in the bracket to secure different sizes of casters to the deck material through the bracket, which may optionally include at least one elongated slots (or two or more elongated slots) for receiving fasteners located at differing and different distances to accommodate casters manufactured by different companies.

The present invention may also be sold as a kit that includes: (i) at least four pieces of lumber having opposing ends cut at forty-five degree angles, where the forty-five degree angles are cut in opposite directions to one another; (2) at least four plate mount swivel casters; and (3) at least four brackets. The at least four brackets in the kit each have a flat plate portion and two side walls positioned perpendicular to one another with a first set of holes in the flat plate for fastening one of the at least four plate mount swivel casters to the lumber through the first set of holes in the bracket. In one example, the four pieces of lumber having opposing ends that are each cut at 45-degree angles in opposing directions such that the ends of opposing lumber may abut to form a corner. The casters are then fastened to the brackets such that the casters are affixed to both ends of the opposing lumber that form the corner. Additionally, openings may be included in the flat plate of the bracket for securing the bracket to the decking material. Such additional openings may also be located such that the bracket is secured directly to both ends of the lumber that form the corners. The present invention also includes a dolly constructed from the materials described in the kit.

The present invention also includes a method for constructing a dolly, the method comprising the steps of (i) cutting at least four pieces of lumber having opposing ends at desired lengths; (ii) cutting the opposing ends of the at least four pieces of lumber at opposing forty-five degree angles; (iii) securing opposing end of the at least four pieces of lumber together by abutting opposing ends of the at least four pieces of lumber to form a rectangle by placing a flat plate of a bracket having two side walls under the abutting corners of the opposing ends of the at least four pieces of lumber such that the two side walls abut the sides of the opposing lumber and (iv) fastening the bracket to the abutting ends of the opposing lumber using fasteners. In one embodiment, the fasteners may be screws, whereas in another embodiment, the fasteners may be plate mount swivel casters that fasten to the lumber through a set of holes in the flat plate of the bracket.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF THE FIGURES

The invention may be better understood by referring to the following figures. The components in the figures are not necessarily to scale, emphasis instead being placed upon illustrating the principles of the invention.

FIG. 1 is a top perspective view of one example of an implementation of a bracket for use in assembling a dolly.

FIG. 2 is a top view of the dolly bracket of FIG. 1.

FIG. 3 is a front view of the dolly bracket of FIG. 2.

FIG. 4 is a side view of the left side of the dolly bracket of FIG. 2

FIG. 5 is a top, front perspective view of the dolly bracket of FIG. 2.

FIG. 6 is a top view of a one example of a dolly assembled using the bracket of FIG. 1.

FIG. 7 is a bottom view of the assembled dolly of FIG. 6.

FIG. 8 is a bottom, side perspective view of the assembled dolly of FIG. 6.

FIG. 9 is a top perspective view of another example of a dolly bracket of the present invention.

FIG. 10 is rear view of the dolly bracket of FIG. 9.

FIG. 11 is top perspective view of another example of a dolly assembled using the dolly bracket of FIG. 9.

FIG. 12 is a bottom perspective view of the dolly of FIG. 11.

FIG. 13 is side view of the dolly of FIG. 11.

### DESCRIPTION OF THE INVENTION

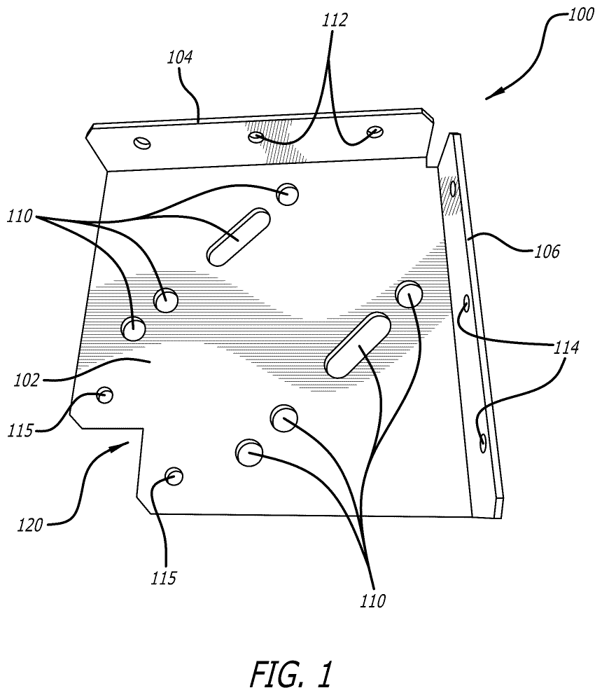

As shown in FIG. 1-13, a bracket 100, 900 also referred to herein as a dolly bracket or bracket, is provided that allows one to construct a dolly 600, 1100 using lumber 602, 1102 and plate mount swivel casters 700, 1200. The dolly bracket 100, 900 secures the end piece of lumber 602, 1102 together to form a flat deck or platform, provides the necessary support to the corners of the lumber 602, 1102 to support the weight of the goods placed on the dolly 600, 1100, and also provides a mechanism for securely fastening plate mount swivel casters 700, 1200 to the corners of the decking. While the bracket 100, 900 may be made of any rigid material, including hard plastic, it is preferable that the bracket be constructed of a metal, such as steel, titanium alloy, or other type of metal commonly used to construct metal braces or heavy-duty brackets.

As further described herein, the dolly brackets 100, 900 can be sold alone, may be sold as part of a kit for constructing a dolly 600, 1100 or may be sold as part of an assembled dolly 600, 1100. A method for using the dolly brackets 100, 900 to construct a dolly 600, 1100 is also within the scope of the present invention. While the illustrated examples of the present invention are designed for use with 2×6 lumber 602, 1102 having a width of 5.5 inches and depth of 1.5 inches, those skilled in the art will recognize that the bracket 100, 900 of the present invention can be sized up or down to accommodate smaller or larger pieces of lumber.

Further, the brackets 100, 900 of the present invention can also be used with a piece of plywood or other flat decking material without departing from the scope of the invention. Optionally, other material may be used in place of the lumber 602, 1102. In addition to lumber 602, 1102, the decking material may also be a hard plastic capable of supporting heavy loads or a made or constructed from metal, such as a metal tubing, for example. Additionally, while the examples provided in this application show the use of plate mount swivel casters 700, 1200, those skilled in the art will recognize that fixed or rigid casters may also be used without departing from the scope of the invention.

While the dolly bracket 100, 900 is taught for use in connection with dollies 600, 1100, the bracket 100, 900 may also be used on the corners of pallets, cabinets, furniture or other objects where the use of wheels may be desired. The bracket 100, 900 may further be used to attach casters 700, 1200 (and even the brackets) temporarily or permanently to decking material, pallets, tubing, furniture and the like.

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

In this application, the term “substantially,” “approximately,” or “about,” when modifying a specified numerical value, may be taken to encompass a range of values that include +/−10% of such numerical value. Further, such as “communicate,” and “in . . . communication with,” or “interfaces” or “interfaces with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate or interface with a second component is not intended to exclude the possibility that additional components may be present between, and/or operatively associated or engaged with, the first and second components.

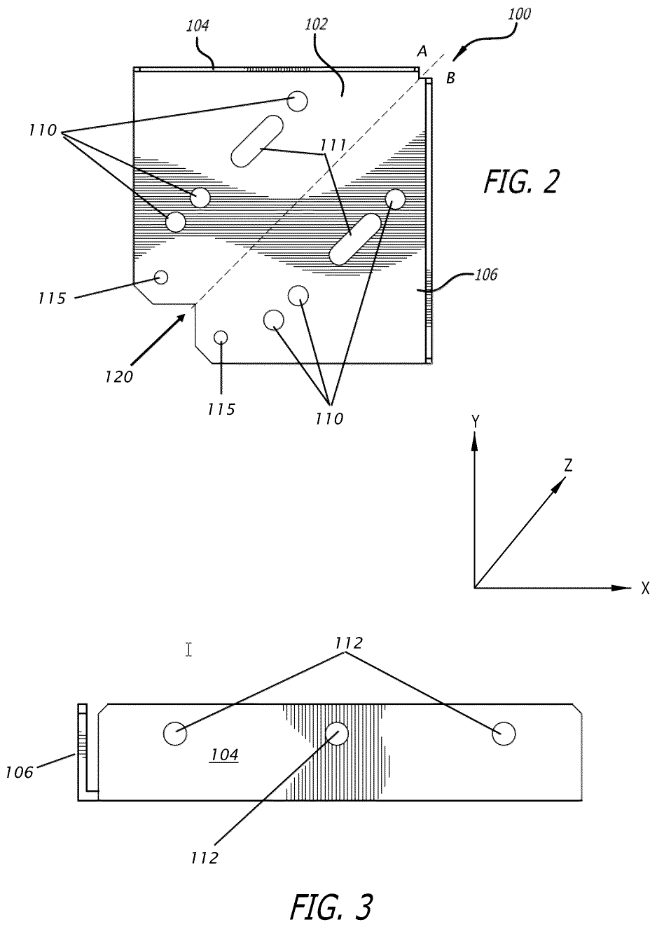

For purposes of reference and description, the bracket 100, 900 is considered to have horizontal (x-axis) and vertical (y-axis) and depth device axis (z-axis), as shown in FIG. 2 along which the components of the bracket 100, 900 are positioned relative to each other. Terms such as “axial” and “axially” are assumed to refer to the respective axis or any direction or axis parallel to the device axis, unless indicated otherwise or the context dictates otherwise. For convenience, movement relative to a device axis may alternatively encompass movement relative to an axis that is parallel to the device axis that is specifically illustrated in FIG. 2, unless the context dictates otherwise. Thus, linear translation “along the device axis z” is not limited to translation directly on (coincident with) the device axis, but also encompasses translation parallel to the device axis z, depending on the context. Similarly, rotation “about the device axis y” also encompasses rotation about an axis that is parallel to the device axis y, depending on the context.

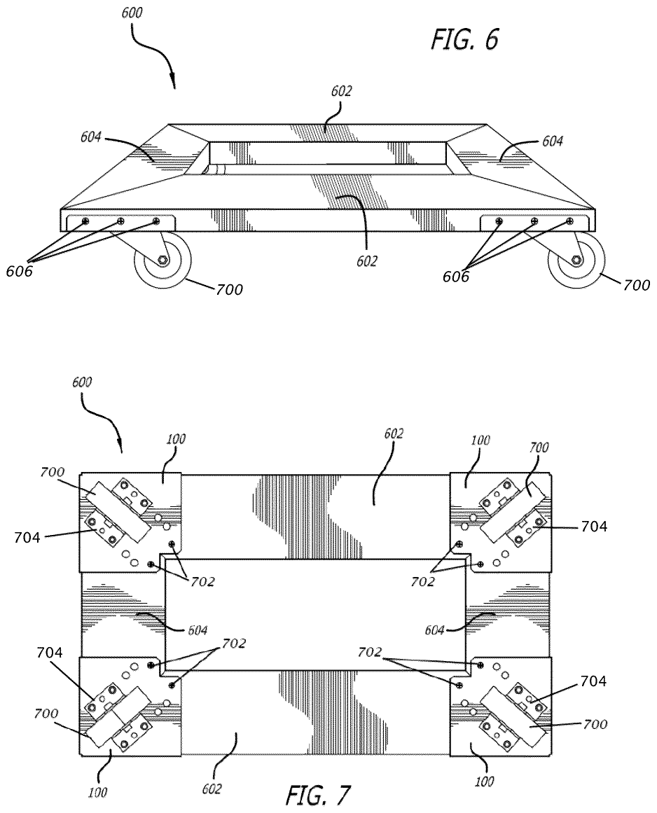

FIG. 1 is a top perspective view of one example of an implementation of a dolly bracket 100 for use in assembling a dolly 600 (FIG. 6). As shown in FIGS. 1-10, the dolly bracket 100 includes a flat plate 102 having two raised side walls 104 and 106 positioned perpendicular to one another for abutting against the exterior sides of the ends of the flat decking material that form the corners of flat decking material of the dolly 600. The flat plate 102 of the bracket 100 further includes a first set of holes 115 for securing the bracket to the material forming the flat deck and a second set of holes 110 for allowing the casters 700 (FIG. 7) to be secured to the flat decking material through the bracket 100. The second set of holes 110 may be comprised of two rows of parallel openings 110 having multiple openings that allow the casters 700 to be adjusted toward and away from the exterior corner of the dolly 100. In this example, the two rows of parallel openings 110 include at least four pairs of aligned openings where the at least four pairs includes one elongated slotted opening 111.

Standard casters 700 (FIG. 7), as shown in FIG. 7, includes a caster plate 704 with generally four bolt holes near each corner of the plate 704 for mounting the casters 700 to objects. The bolt holes are generally spaced at 1¾ inch by 3 inches apart on the caster plate 704. By providing at least four pairs of openings in the flat plate 102 of the dolly bracket 100, where one pair includes an elongated slotted opening 111, the bolt holes of the casters plate 704 aligns with the parallel openings 110 at various positions along the dolly bracket 100 to allow the casters 700 to be aligned closer to, or a further from, the outside corner of the dolly 600. The elongated slotted 111 allows for the brackets 100 to accommodate casters 700 that have bolt holes in the caster plates 704 that differ slightly from standard, as well as allow the casters 700 to be affixed at three different positions along the plate 102 of the dolly bracket 100. For example, with the elongated slot 111, the bolt holes in the casters plate 704 can attach to either the first pair of openings 110 and elongated slots 111, elongated slots 111 and third pair of opening 110 or elongated slots 111 and fourth pair of openings 110.

Here, the second set of holes 110 do not need to be rows of openings but may just be sets of openings for aligning with bolt holes in a caster. For example, the holes could be positioned to align with the bolt holes in the caster plate 704 whether the caster plate is positioned as 1¾ inch by 3 or as 3 by 1¾ inches across the centerline of the dolly bracket 100. Given that the holes are spaced apart at either 1¾ inch along one axis and 3 inches along the other axis, the second set of holes 110 should be spaced apart at either 1½ inch or ⅞ of an inch from the centerline to match the bolt holes in the caster plate in either positioned either long or short way across the centerline. Alternatively, the sets of holes could include at least two or more holes at both 1½ inch or ⅞ of an inch from the centerline.

The raised side walls 104 and 106 also each include a third and fourth set of holes 112 and 114 for securing the side walls 104 and 106 of the bracket 100 to the sides of the material forming 602 and 604 (FIG. 6) the flat deck of the dolly, which sides abut the raised side walls 104 and 106 of the dolly bracket 100. The flat plate 102 may further include a notch 120 on the corner of the bracket 100 opposite the corner formed by the two raised side walls 104 and 106.

FIG. 2 is a top view of the dolly bracket 100 of FIG. 1. FIG. 2 illustrates the flat plate 102 being a generally rectangular shaped plate having two perpendicular raised side walls 104 and 106—one on the top and one of right side of the bracket 100 as shown in FIG. 2. The illustrated bracket 100 may be sized for use in connection with lumber 602, 604 (FIG. 6) being, for example, 2×4, 2×6 or 2×8 sized lumber 602, 604. When used in connection with 2×6 pieces of lumber 602, 604, having a true width of 5.5 inches and depth of 1.5 inches. The dolly bracket 100 is approximately 6.5 inches by 6.5 inches measured along the x and y axis of the flat plate 102 of the dolly bracket 100. Since the lumber is only 5.5 inches wide, notch 120 removes the portion of the bracket 100 that would extend past the inside corner of the dolly 100 formed by the lumber 602, 604 (FIG. 6). For 2×4 and 2×8 lumber 602, 604, the flat plate 102 may measure 3.5×3.5 and 7.5×7.5 respectively. Those skilled in the art can scale the dolly bracket 100 up and down to accommodate different sizes of lumber 602, 604.

As seen in FIG. 2, the dolly bracket 100 is constructed to have two sides: A & B, each of which are mirror images of one another taken along a centerline, as shown in FIG. 2, which is taken at a forty-five degree angle relative to the x and y-axis. Each side is constructed to receive and secure one an adjoining end of lumber 602, 604 to create a corner of the dolly 600. Each side has a raised side walls 104 or 106, has a flat plate portion 102, has one row of openings 110 for securing a caster 700 to the one side of the lumber 602 or 604 used to create the corner of the dolly 600, and one hole 115 for securing the dolly bracket 100 to the one side of the lumber 602 or 604 used to create the corner of the dolly 600.

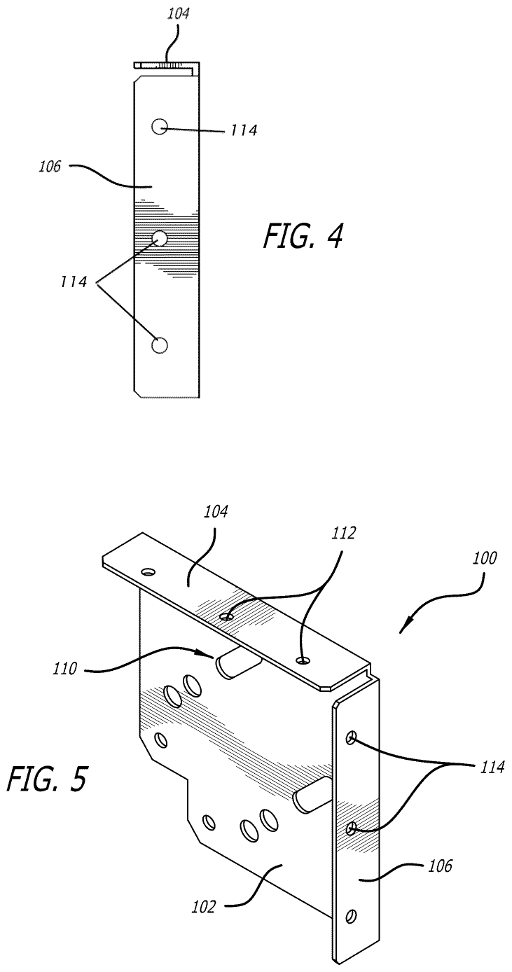

FIG. 3 is a front view of the dolly bracket 100 of FIG. 2 illustrating the top side wall 104 of the bracket 100. Similarly, FIG. 4 is a side view of the dolly bracket 100 of FIG. 2 illustrating the right side wall 106 of the bracket 100. As shown, in this example, the raised side walls 104 and 106 are approximately 1.25 to 1.5 inches high measured from the bottom of the flat plate 102 of the bracket 100 (along the z-axis). As such the side walls 104 and 106 do not extend beyond the thickness of the 2×6 inch piece of lumber, and would remain the same height for 2×4 and 2×8 lumber and also not extend beyond the thickness of the lumber used to create the platform of the dolly 100. To provide a flat surface, the side walls 102 and 106, regardless of the thickness of the lumber, should be equal to or less than the thickness of the lumber to maintain a flat deck surface.

FIG. 5 is a front, top perspective view of dolly bracket 100. FIG. 5 best illustrates the side walls 104 and 106 converging toward an exterior corner of the flat deck 102. The side walls 104 and 106 do not, however touch, but leave a slight gap in the corner for receiving an exterior corner of the flat deck surface formed by the lumber 602, 604, as described further below. The set of holes 112 and 114 are for receiving fasteners to secure the bracket 100 to the sides of the lumber that form the flat deck surface.

As shown above, the set of holes 110 for securing the casters to the lumber through the dolly bracket 100 includes two parallel rows of holes 100. At least one row of the parallel holes 100 aligns with one piece of lumber 602 forming the corner of the dolly 100 and the other row of holes 100 aligns with the second piece of lumber 604 forming the corner of the dolly 100 when assembled. In this manner, one side of the caster 700 (FIG. 7) is secured to one piece of lumber 604 forming the corner and the other side of the caster 700 is secured to the second piece of lumber 602 forming the corner.

FIG. 6 is a top front perspective view of a one example of a dolly 600 assembled using the dolly bracket 100 of FIGS. 1-5. In this example, the flat deck of the dolly 600 is made from four 2×6 pieces of lumber 602, 604 each having opposing ends cut at a 45-degree angle, where the 45-degree angles are cut in opposing relationship with one another such that each piece of lumber 602, 604 is cut in a trapezoidal shape. To create a rectangular shaped platform on the dolly 600, two pieces of lumber may be cut shorter 604 and two pieces may be cut longer 602; however the two short pieces 604 must be the same length as one another and the two longer pieces 602 must be the same length as one another. The two shorter pieces 604 may be placed parallel to one another with the shorter side of the trapezoid of each piece of lumber 604 facing the other. The two longer pieces 602 are then positioned perpendicular to the shorter pieces 604 in parallel relationship to one another 602 with one positioned on each end of the shorter pieces 604 of lumber. Again, the shorter side of the trapezoid of each piece of longer lumber 602 is positioned to face one another. In this manner, the 45 degree ends of the longer pieces of lumber 602 will abut the 45 degree ends of the shorter pieces of lumber 604, forming the corners of a rectangle, as shown in FIG. 6.

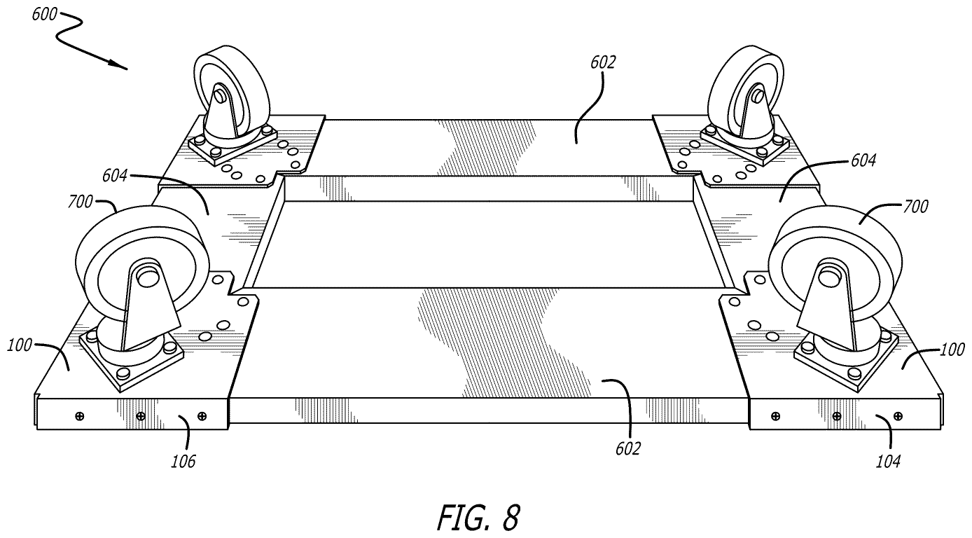

FIG. 7 is a bottom view of the assembled dolly 600 of FIG. 6, and FIG. 8 is a front, bottom perspective side view of the assembled dolly 600 of FIG. 6. As shown, one side of each caster 700 is secured to one of two pieces of lumber 602 forming the corner of the dolly 600 and the other side of the caster 700 is secured to the other of the two pieces of lumber 604 forming the corner. The casters 700 are secured to the lumber 602, 604 through the parallel openings 110 on the flat plates 102. In this example, casters 700 are secured to the lumber 602, 604 through the openings on the flat plates 102 nearest the exterior corners of the dolly 600. Additional fasteners 702, which in this case are screws, are shown near the interior bottom corners of the dolly 600 securing the flat plate 102 of the bracket 100 to the lumber 602, 604. One fastener is secured to one piece of lumber 602 forming the corner and another fastener is secured to the second piece of lumber 604. The raised side walls 104, 106 abut the exterior sides of the opposing lumber pieces 602, 604 and are fastened to the sides of the opposing lumber pieces 602, 604 using fasteners 606.

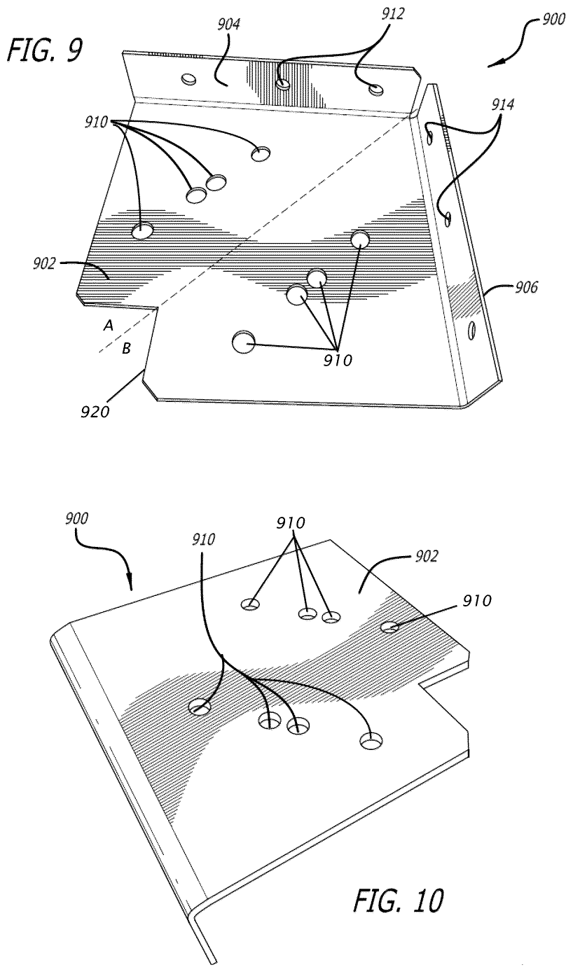

FIG. 9 is a top view of another example of a dolly bracket 900 of the present invention, and FIG. 10 is rear view of the dolly bracket 900 of FIG. 9. Here, the flat plate 902 of the bracket 900 includes two parallel sets of openings 910, consisting of four pairs of openings for receiving fasteners for swivel plate casters, and openings 912, 194 on the raised side walls 906, 906. In this example, the openings 910 are all circular shaped openings that align with the bolt holes in the caster plates 1204 of the casters 1200. In this embodiment, the bolt holes in the caster plates 1204 of the casters 1200 would align with either the first and third pair of openings or the second and fourth pair of openings to vary the positioning of the caster 1200 on the dolly bracket 900. In this example, additional openings for securing the bracket 900 to the flat platform are not provided (similar to the holes 115 in the example shown in FIG. 1-8); however, unused and exposed openings 910 for securing the casters 1200 to the flat decking may be used to secure the bracket directly to the flat decking rather than indirectly through the casters 1200, if desired. Except for this variation and use of the openings 910 in the flat plate 902 of the bracket 900, all elements of the dolly bracket 900, dolly bracket 900 size and construction, dolly kit, and construction of the dolly 900 remain as described in connection with FIG. 1-8 with corresponding parts.

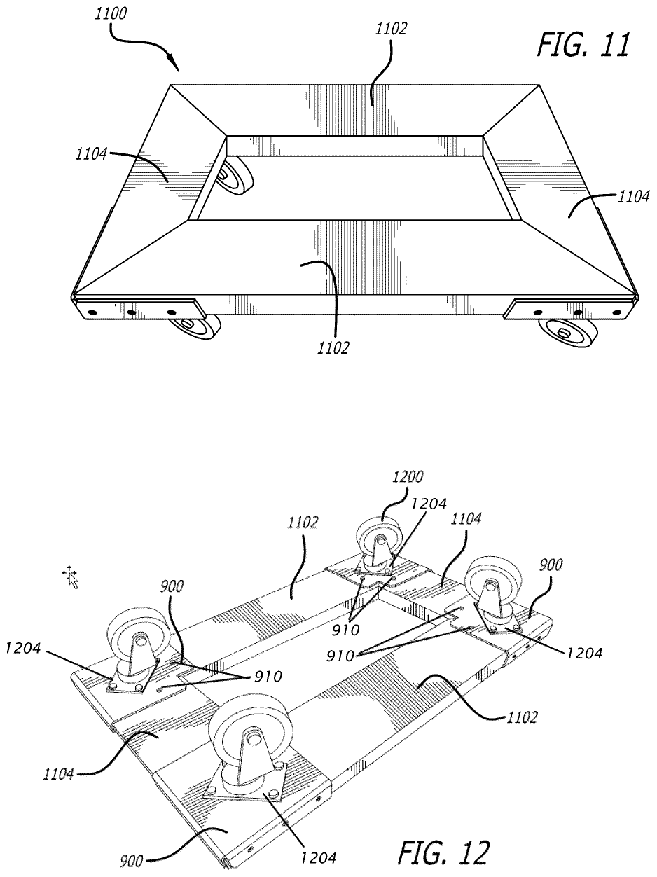

As seen in FIG. 9, like the dolly bracket 100 in FIG. 2, the dolly bracket 900 is constructed to have two sides: A & B, each of which are mirror images of one another taken along a centerline, as shown in FIG. 9, which is taken at a forty-five degree angle relative to the x and y-axis, which is the same as set forth in FIG. 2. Each side is constructed to receive and secure one an adjoining end of lumber 1102, 1104 (FIG. 11) to create a corner of the dolly 1100 (FIG. 11). Each side has a raised side walls 904 or 906, has a flat plate portion 902, has one row of openings 910 for securing a caster 1200 to the one side of the lumber 1102 or 1104 used to create the corner of the dolly 1100.

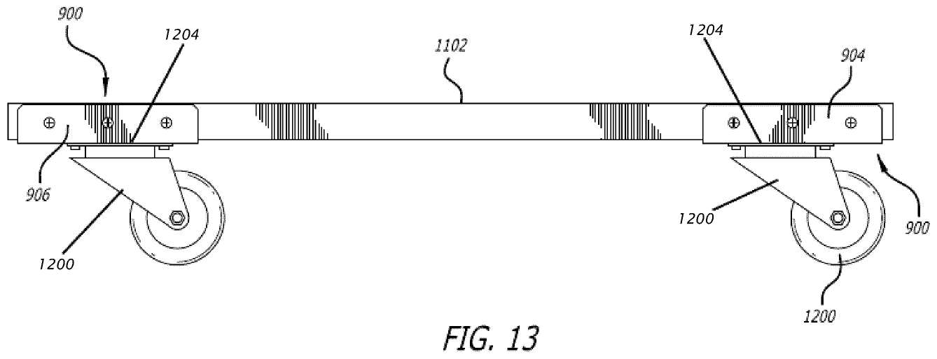

FIG. 11-13 shows another example of an assembled dolly 1100 using dolly bracket 900 of FIGS. 9-10. FIG. 11 is top perspective view of another example of a dolly 1100. FIG. 12 is a bottom perspective view of the dolly 1100 of FIG. 11, and FIG. 13 is side view of the dolly 1100 of FIG. 11. Here, one side of each caster 1200 is secured to one of the two pieces of lumber 1102, 1104 forming the corner of the dolly 1100 and the other side of the caster 1200 is secured to the other of the two pieces of lumber 1104 forming the corner. Like in the prior example in FIG. 1-8, the casters 1200 and the same as casters 700 in FIG. 1-8 and include caster plates 1204 having bolt holes positions on the corners of the caster plate at standard distances. In this example, the caster 1200 is secured by positioning fasteners, (i.e., screws) through the openings on the caster plate 1204 aligned with openings on the flat plate 902 of the dolly bracket 900 to secure the casters to the lumber 1102, 1104 of the dolly 1100. In this example, the casters 1200 are secured through the openings 910 that position the caster 1200 nearest the exterior corners of the dolly 1100. One fastener is secured to one piece of lumber 1102 forming the corner and the other fastener is secured to the second piece of lumber 1104. Again, the raised side walls 904, 906 abut the exterior sides of the opposing lumber pieces 1102, 1104 and are fastened to the sides of the opposing lumber pieces 904, 906 using fasteners.

The brackets 100 and 900 may be sold separately or sold assembled as part of a dolly 600 and 1100. Further, the brackets 100 and 900 could be sold as part of the kit for creating a dolly. Such a kit may include at least four pieces of lumber have opposing ends cut at forty-five degree angles at opposite directions to one another; at least four plate mount swivel casters; and at least four brackets each having a flat plate portion and two side walls positioned perpendicular to one another, a first set of parallel holes in the flat plate of the bracket for securing the at least four plate mount swivel casters to the lumber through the set of parallel holes in the bracket. At least one row of the parallel holes of the first set of holes aligns with one piece of lumber 602 forming the corner of the dolly 1100 and the other row of parallel holes of the first set of holes aligns with the second piece of lumber 604 forming the corner. Selling the brackets as part of a kit can minimize the size of packaging and shipping needed for the dolly.

In operation, to construct a dolly from the brackets 100, 900, the method for construction includes (i) cutting at least four pieces of lumber having opposing ends at desired lengths where the ends of the at least four pieces of lumber are cut at opposing angles; (ii) securing opposing end of the at least four pieces of lumber together by abutting opposing ends of the at least four pieces of lumber to form a rectangle by placing a flat plat of a bracket having two side walls under the abutting corners of the opposing ends of the at least four pieces of lumber such that the two side walls abut the sides of the opposing lumber; (iii) fastening the bracket to the abutting ends of the opposing lumber using fasteners positioned through a first set of holes in the flat plate of the bracket; and (iv) securing the bracket to lumber through a second set of holes for fastening one of the at least four plate mount swivel casters to the lumber through the second set of holes in the bracket. In the example shown in this application, the angle at which the ends are cut is preferably a 45-degree angle, cut on each end in opposing direction such that lumber is cut in the shape of a trapezoid. The lumber being 2×4, 2×6 or 2×8 sized lumber, by way of example.

At least two of the four pieces of lumber 602, 604, 1102, 1104 are cut to be shorter than other two pieces of lumber to create a rectangular dolly, as described above. However, the shorter pieces are cut to the be same length as one another and the longer pieces are cut to be the same length as one another. Alternatively, the dolly may be constructed to be square if all four pieces of lumber are cut to the same length. Further, square or rectangular plywood could be used in place of lumber without departing from the scope of the inventions. Optionally, plywood can also be affixed to the top of pieces of lumber 602, 604, 1102, 1104.

While the invention described is a dolly bracket, a dolly designed using a dolly bracket, a kit to create a dolly using the dolly bracket and method of constructing a dolly using the dolly bracket, those skilled in the art will recognize that the dolly bracket design is not limited to the examples shown here in. For example, dolly brackets can be designed for use with 2×4 lumber, which in this case, the dolly brackets in accordance with the present invention would be approximately 4.5 inches by 4.5 inches. Similarly, the dolly brackets can be designed for use with 2×8 pieces of lumber, in which case the brackets would be approximately 8.5 inches by 8.5 inches. The raised walls will, in these examples, remain the same height as the thickness of all boards are the same.

When cutting the lumber or providing lumber or other deck material in a kit or for construction, the length of the lumber or deck material may vary depending upon the needs of the user. For example, the board lengths may create a deck that is, for example, 18×36 inches, 18×30 inches, 24×36 inches, 24×48 inches or 36×48 inches to provide a few examples. The length of the lumber must be longer than the length of the two brackets placed next to one another and may vary from there by length depending upon the application, bracket size and size and thickness of the lumber used. If plywood sheets are used in place of lumber, such sheets could be 18×36 inches, 18×30 inches, 24×36 inches, 24×48 inches or 36×48 inches to provide a few examples. Again, plywood can also be optionally affixed to the top of pieces of lumber 602, 604, 1102, 1104 to fit the size of the platform formed by the lumber 602, 604, 1102, 1104.

Other devices, apparatus, systems, methods, features and advantages of the invention will be or will become apparent to one with skill in the art upon examination of the following figures and detailed description. It is intended that all such additional systems, methods, features and advantages be included within this description and be within the scope of the invention. The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A bracket for creating a dolly of deck material, the bracket having a flat plate portion having two side walls positioned perpendicular to one another where the side walls each include a first set of holes, the bracket further including a second set of openings in the flat plate for fastening a caster to the deck material through the second set of openings in the bracket.

2. The bracket of claim 1 having a centerline where the second set of openings are comprised of two parallel rows of openings with one of the at least two parallel rows of openings positioned on one side of the centerline of the bracket and the other row of the two parallel rows is positioned on the opposite side of the centerline of the bracket.

3. The bracket of claim 1 having a centerline, where the bracket on the right side of the centerline is a mirror image of the bracket on the left side of the center line.

4. The bracket of claim 1 where the bracket is approximately 5.5 inches long by 5.5 inches wide and the two side walls are approximately 1.25 to 1.5 inches high.

5. The bracket of claim 1 where the bracket is approximately 3.5 inches long by 3.5 inches wide and the two side walls are approximately 1.25 to 1.5 inches high.

6. The bracket of claim 1 where the bracket is approximately 7.5 inches long by 7.5 inches wide and the two side walls are approximately 1.25 to 1.5 inches high.

7. The bracket of claim 1 having a centerline where the second set of openings including at least one pair of opening positioned at either 1½ inch or ⅞ of an inch from each side of the centerline.

8. The bracket of claim 1 having a centerline where the second set of openings including at least two pairs of opening positioned at either 1½ inch or ⅞ of an inch from each side of the centerline.

9. A kit for creating a dolly, the kit comprising:
at least four pieces of lumber have opposing ends cut at forty-five degree angles, where the forty-five degree angles at opposing ends of the lumber are cut in opposite directions to one another;
at least four plate mount swivel casters; and
at least four brackets each having a flat plate portion having two side walls positioned perpendicular to one another where the side walls each include a first set of holes, the bracket further including a second set of openings in the flat plate for fastening one of the at least four plate mount swivel casters to two of the at least four pieces of lumber through the second set of openings in the bracket.

10. The kit of claim 9 where the at least four brackets each have a centerline and where the second set of openings on the at least four brackets are comprised of two parallel rows of openings with one of the at least two parallel rows of openings positioned on one side of the centerline of the bracket and the other row of the two parallel rows positioned on the opposite side of the centerline of the bracket.

11. The kit of claim 9 where each of the at least four brackets has a centerline with a right and left side and where the right side of each of the at least four brackets is a mirror image of the left side of each of the at least four brackets.

12. The kit of claim 9 where two of the at least four pieces of lumber are shorter than another two of the at least four pieces of lumber, and where the shorter two of the at least four pieces of lumber are the same length and the longer two of the at least four pieces of lumber are the same length.

13. The kit of claim 9 where the bracket is approximately 5.5 inches long by 5.5 inches wide and the two side walls are approximately 1.25 to 1.5 inches high.

14. The kit of claim 9 where the bracket is approximately 3.5 inches long by 3.5 inches wide and the two side walls are approximately 1.25 to 1.5 inches high.

15. The kit of claim 9 where the bracket is approximately 7.5 inches long by 7.5 inches wide and the two side walls are approximately 1.25 to 1.5 inches high.

16. The kit of claim 9 where bracket has a centerline and where the second set of openings including at least one pair of opening positioned at either 1½ inch or ⅞ of an inch from each side of the centerline.

17. The kit of claim 9 where bracket has a centerline and where the second set of openings including at least two pairs of opening positioned at either 1½ inch or ⅞ of an inch from each side of the centerline.

18. A method for constructing a dolly, the method comprising the sets of:
cutting at least four pieces of lumber having opposing ends at desired lengths where the ends of the at least four pieces of lumber are cut at opposing angles;
securing opposing end of the at least four pieces of lumber together by abutting opposing ends of the at least four pieces of lumber to form a rectangle and by placing a flat plate of a corner bracket having two side walls under each of the abutting corners of the opposing ends of the at least four pieces of lumber such that the two side walls abut the sides of the opposing lumber;
fastening each of the corner brackets to the abutting ends of the opposing lumber using fasteners positioned through a first set of holes in the flat plate of the bracket; and
securing the bracket to lumber through a second set of openings for fastening one of the at least four plate mount swivel casters to the lumber through the second set of holes in the bracket.

19. The method of claim 18 where the opposing ends of at least four pieces of lumber are cut at forty-five degree angles, where the forty-five degree angles at opposing ends of the lumber are cut in opposite directions to one another and where two of the at least four pieces of lumber are shorter than another two of the at least four pieces of lumber, and where the shorter two of the at least four pieces of lumber are the same length and the longer two of the at least four pieces of lumber are the same length.

20. The method of claim 19 where each corner has a centerline with a right and left side and where the right side of each of the at least four brackets is a mirror image of the left side of each of the at least four brackets.
